(19) United States
(12) Patent Application Publication
(10) Pub. No.: US 2013/0347063 A1
(43) Pub. Date: Dec. 26, 2013

(54) HANDLING CLAIMS TRAVERSING SECURITY BOUNDARIES

(71) Applicants: Sarath Madakasira, Kirkland, WA (US); Siddharth Bhai, Kirkland, WA (US); James J. Simmons, Carnation, WA (US); Ryan J. Fairfax, Redmond, WA (US); Qi Cao, Sammamish, WA (US); Arun K. Nanda, Sammamish, WA (US); Mark Fishel Novak, Newcastle, WA (US)

(72) Inventors: Sarath Madakasira, Kirkland, WA (US); Siddharth Bhai, Kirkland, WA (US); James J. Simmons, Carnation, WA (US); Ryan J. Fairfax, Redmond, WA (US); Qi Cao, Sammamish, WA (US); Arun K. Nanda, Sammamish, WA (US); Mark Fishel Novak, Newcastle, WA (US)

(73) Assignee: MICROSOFT CORPORATION, Redmond, WA (US)

(21) Appl. No.: 13/529,853

(22) Filed: Jun. 21, 2012

(51) Int. Cl. G06F 21/00

(52) U.S. Cl. 726/2

(57) ABSTRACT

Sharing security claims across different security contexts. A method includes, for a first security context, identifying a first set of security claims. The method further includes for the first security context identifying a second set of security claims from the first set of security claims that is allowed to be sent from the first security context. The first set of security claims is modified to create the second set of security claims. For a second security context, security claim requirements are identified. The second set of security claims is modified to satisfy the security claim requirements for the second security context.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing systems ability to be interconnected to other computing systems via network connections. Network connections may include, but are not limited to, connections via wired or wireless Ethernet, cellular connections, or even computer to computer connections through serial, parallel, USB, or other connections. Further still, some computing systems may implement different entities on the same machine, but allow the entities to communicate with each other.

When communicating with each other, entities often have some sort of trust level. In some systems this trust level can be established by using security claims. A security claim (or simply claim) is an assertion made about an entity by a security authority. Such claims may define an entity's role, an entity's privileges, the level to which an entity is to be trusted, etc. Claims are interpreted uniformly within a given security context. However, the semantics of claims and the claim values can vary greatly between different security authorities. Claims by a security authority are generally relevant to a particular security context. However, using security claims between security contexts can be more difficult.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment includes a method that may be practiced in a computing environment having a plurality of security contexts. The method includes acts for sharing security claims across different security contexts. The method includes, for a first security context, identifying a first set of security claims. The method further includes for the first security context identifying a second set of security claims from the first set of security claims that is allowed to be sent from the first security context. The first set of security claims is modified to create the second set of security claims. For a second security context, security claim requirements are identified. The second set of security claims is modified to satisfy the security claim requirements for the second security context.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates security claim transformation between security contexts in the same security envelope;

FIG. 2 illustrates security claim transformation between security contexts in different security envelopes; and

FIG. 3 illustrates a method of sharing security claims across different security contexts.

### DETAILED DESCRIPTION

As noted previously, a claim is an assertion made about an entity by a security authority. A security context is a scope within which claims are interpreted uniformly. The semantics of claims and the claim values can vary greatly between different security authorities. A security authority is authoritative for claims within a given security context. The role of a security authority can be held by one or more devices in a given security context.

A security envelope is a collection of one or more security contexts with implicit (direct or indirect) full trust between any two security contexts.

A security boundary is the boundary of direct explicit trust between two security authorities in different security envelopes. This trust is less trusted by a security authority than the implicit trust within the security envelope.

Some embodiments described herein implement a claims transformation engine that is responsible for transforming claims when they enter or exit a security context. In this way, a set of claims for one security context can be repurposed for a different security context. In particular, the transformation engine may: filter claims from either leaving or entering a security context; substitute claims for claims that are either leaving or entering a security context, add claims to a set of claims leaving or entering a security context; modify claims that are either entering or leaving a security context; etc.

One skilled in the art will recognize that a claim may consist of one or more values that a security authority is asserting about the entity. In this way, a claim can be a single-valued claim or a multi-valued claim. Additionally, there may be multiple claims, including single-valued and multi-valued, about an entity. One skilled in the art will also recognize that a set of claims may consist of one or more claims about one or more entities. In this way, a set of claims can be a single-valued claim about one entity, one or more single-valued or multi-valued claims about one or more entities, or any combination thereof.

Allowing complex claims across two security contexts is done using special handling of claims to modify and adapt them from one security context to the other. Each security context is protected when allowing claims to traverse from/to different security contexts. This may be particularly important when the two security contexts reside in different security envelopes and share a direct or indirect security boundary because the two security contexts do not fully trust each other. As noted above, claims can flow across two security contexts in both directions. Thus, some embodiments may allow customers to independently configure handling of claims flowing in both the directions.

Claims flowing across security contexts are essentially flowing between the realms of different security authorities. Thus, the claims transformation engine will follow the security requirements of the corresponding security authority in issuing claims, thus ensuring a chain of trust across security contexts.

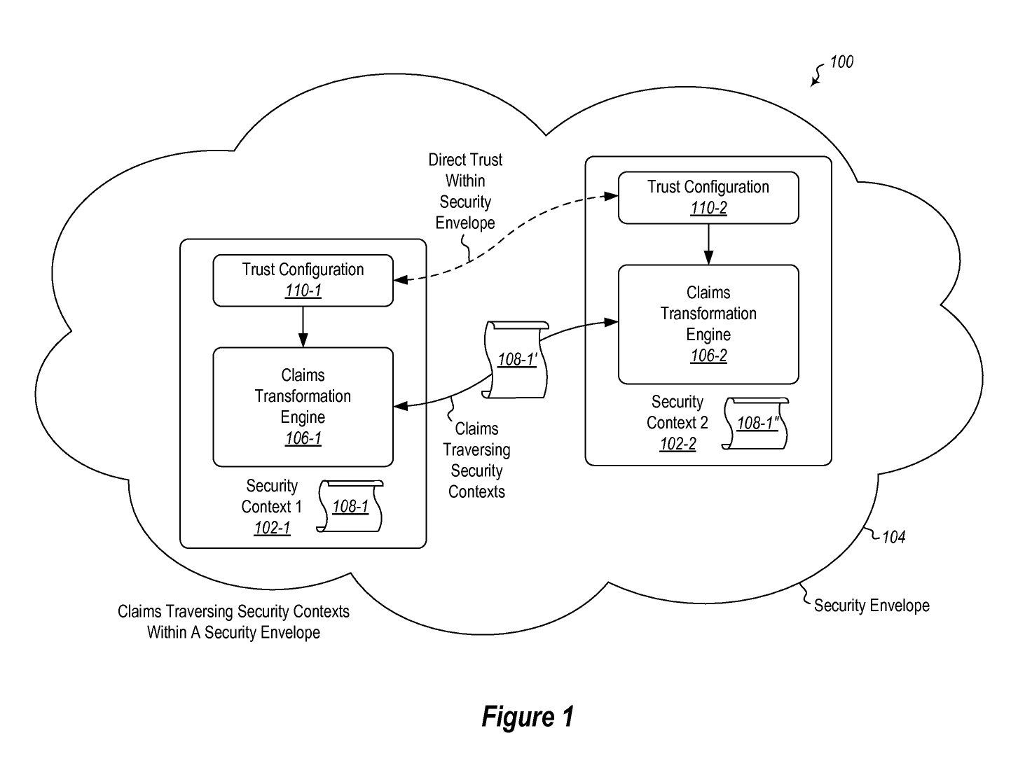

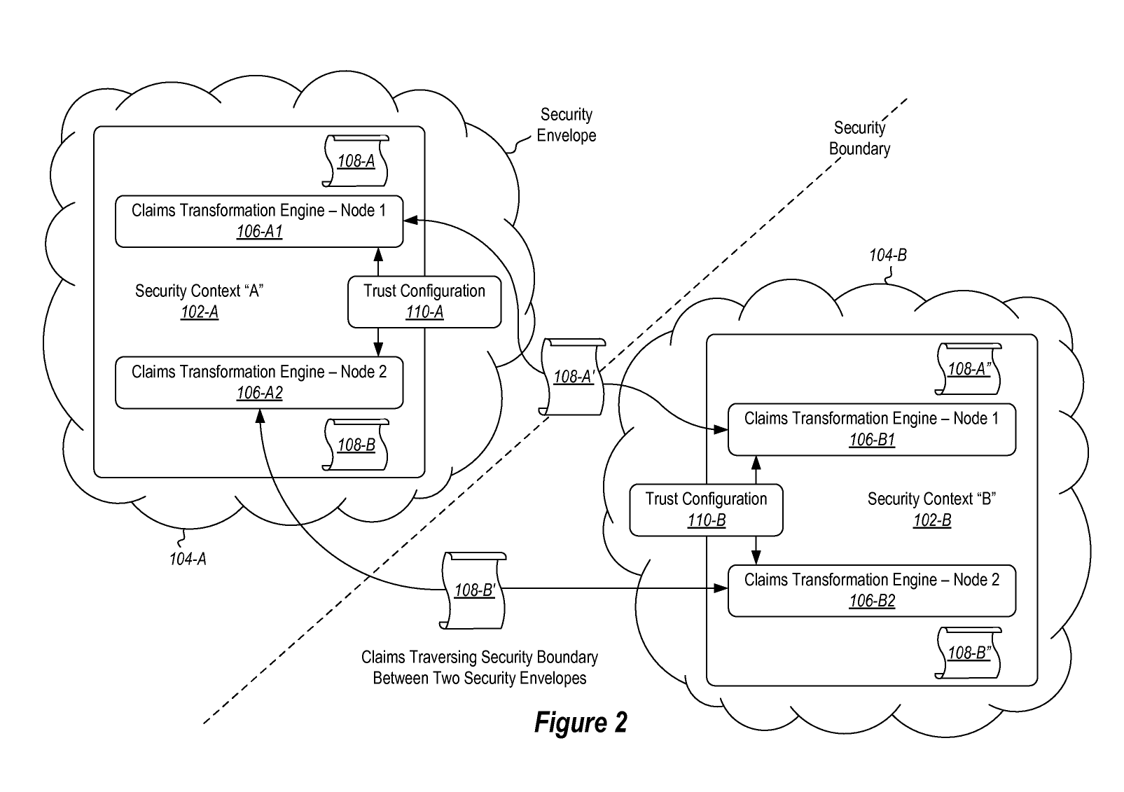

Embodiments may help to facilitate direct trusts between both security contexts 102-1 and 102-2 that are within the same security envelope 104 as illustrated in FIG. 1 and security contexts 102-A and 102-B in different security envelopes 104-A and 104-B as illustrated in FIG. 2. Security contexts are referred to herein generically as 102 and security envelopes are referred to herein generically as 104. Specific examples of each can be seen in the Figures with additional designators to differentiate between specific instances. This may be accomplished in a number of different ways. Illustratively, embodiments may implement a claims transformation engine (such as claims transformation engines 106-1, 106-2, 106-A1, 106-A2, 106-B1 and 106-B2, but referred to herein generically as 106) with functionality to handle a given set of claims traversing the direct trust between two security contexts (e.g., claims 108-1′ traversing between security contexts 102-1 and security context 102-2; claims 108-A′ traversing between security contexts 102-A and 102-B and claims 108-B′ traversing between security contexts 102-A and 102-B) by performing one or more of: filtering claims for the given set of claims, substituting claims for claims in the given set of claims, transforming claims in the given set of claims or issuing new claims to the given set of claims. Alternatively or additionally, embodiments may implement the ability to independently configure handling claims traversing in each direction across a direct trust between two security contexts. Alternatively or additionally, embodiments may implement the ability of a claims transformation engine to issue a set of claims in accordance with the security requirements of a security authority. Alternatively or additionally, embodiments may prevent detectable misconfigurations from compromising the security of a security context while allowing claims across the direct trust between two security contexts. Alternatively or additionally, embodiments may implement default handling of claims crossing a direct trust between security contexts when no configuration is provided. Each of these aspects will be discussed in more detail below.

Prior to transforming the claim or claims to cross from one security context to another, the claims may be identified. In one embodiment all claims about one entity are identified. However, claim identification is not limited to a single entity. Claim identification may also include a subset of claims about one or more entities.

As noted above, some embodiments may implement a claims transformation engine 106 with functionality to handle a given set of claims traversing the direct trust between two security contexts by performing one or more of: filtering claims for the given set of claims, substituting claims for claims in the given set of claims, transforming claims in the given set of claims or issuing new claims to the given set of claims.

A claims transformation engine 106 will handle a set of claims traversing the direct trust between two security contexts by performing a variety of operations on them, based on a configuration. As noted, such operations performed by the claims transformation engine 106 may include filtering, substituting, or transforming a given set of claims, issuing new claims, etc. The operations can be performed on zero or more claims taken from the given set of claims or on the intermediate processing results of other operations on claims.

Operations are performed predictably on any given claim set such that the results are repeatable. Additionally, customers are able to adapt or configure the operations performed to the requirements of their own needs. Illustratively, a claims transformation engine 106 can be programmed by a customer to transform claims at a security boundary. In some embodiments, one way to implement a configuration that the claims transformation engine 106 uses is by defining a formal language grammar and semantics. This can be done to make the configuration human readable and make it easy to understand how the claims have to be handled by a claims transformation engine 106 at a security boundary. In the examples illustrated herein, this language is called the “transformation rules language”. A set of instructions to handle or transform claims written in this language is referred to simply as “rules”. In some embodiments, the rules are encapsulated in an XML format to enable storing various versions of the rules side-by-side. Further, embodiments may implement a method to validate rules written in the transformation rules language and encode them into a machine format that can be used by the claims transformation engine 106.

The following describes the operation of the claims transformation engine 106. The claims transformation engine 106 operates on a given set of input claims using a set of machine-encoded rules and produces output claims. Embodiments may be implemented where no state is stored by the transformation engine in between operating two given sets of claims, which can be used to produce essentially identical output for identical input.

The set of rules can have zero or more individual rules. In some embodiments, the embodiments can be configured where these rules are processed in order. In these embodiments, intermediate state can be stored between the processing of rules, which may then be used in the processing other rules.

In some embodiments, a rule may contain one or more conditions. The embodiments can be configured where these conditions are processed in order. In these embodiments, claims may be identified from the set of input claims to be processed for transformation.

The claims transformation engine 106 can select zero or more claims by matching claims' type or value and value type based on equality or inequality expressions. The claims transformation engine 106 generates output claims using the selected claims or by issuing a fixed claim or a combination thereof. The final output claims are processed to remove any duplicate claims.

For example, in some embodiments using Windows® Server available from Microsoft® Corporation of Redmond Wash., SID filtering may be used to filter claims from a set of claims. This removes certain well-known security identifiers from a set of security identifiers traversing a security boundary.

In yet another embodiment, the final output claims may be processed to aggregate more than one single-valued claim of the same type, remove duplicates, and put the remaining single-valued claims into one multi-valued claim.

In yet another embodiment, the final output claims may be processed to remove any claims that are not a valid claim type.

As noted above, embodiments may include the ability to separately configure handling of claims traversing in each direction across a direct trust between two security contexts. A claims transformation engine 106 can be independently configured to handle claims flowing in each direction of the direct trust between two security contexts. The claims transformation engine 106 can choose the configuration for handling the claims based on the trust and the direction of traversal of the claims. As illustrated in FIGS. 1 and 2, a trust configuration 110-1, 110-2, 110-A and 110-B (referred to generically as 110) is implemented for each security context 102-1, 102-2, 102-A and 102-B respectively. The claims transformation engine 106 validates the configuration 110 chosen for the direct trust between two security contexts 102 and direction of claims traversal. This includes checking the properties of the trust and the configuration to handle the claims. The claims transformation engine 106 uses the chosen configuration to handle the claims so long as it is determined that the configuration is correct and valid.

The following illustrates an example. Consider two security contexts A and B connected by a one-way trust X. Security context B trusts security context A and allows entities in security context A to use the security credentials issued through trust X to access resources in security context B. Also, security context A is claims-enabled and issues zero or more claims in each principal's security credentials. Note that the claims flow in the opposite direction of the trust.

A principal's claims leave security context A and enter security context B across trust X. These claims are handled at the point of egress in security context A and at the point of ingress in security context B. It is possible to configure the trusts in both of these contexts using the transformation rules language described above to transform the claims. I.e. a set of claims could be transformed twice when traversing a trust. While the illustrated example uses a transformation rules language as a means of configuring the claims transformation engine 106, this is just one way of implementing this and it could be implemented in a number of different ways.

Security context A and security context B may constitute different security envelopes and have their own representations of trust X, such as in the example illustrated in FIG. 2. To define rules for handling claims leaving security context A, the rules are associated with trust X and the claims travel in the direction of “egress”. Similarly in security context B, the rules are associated with trust X and the claims travel in the direction of “ingress”.

As noted above, embodiments may include the ability of a claims transformation engine to issue a set of claims in accordance to the security requirements of the security authority. A claims transformation engine 106 in a security context 102 issues claims to principals. These claims are issued in accordance to the security requirements followed by the security authority of the corresponding security context. This is to maintain security and chain of trust across multiple connected security contexts. The input claims to the claims transformation engine 106 are verified as issued by a trusted security authority. The issued claims are issued so as to be valid as identified by the security authority. The issued claims are protected by a means accepted by the corresponding security authority to maintain security and prevent tampering and repudiation of claims. The claims transformation engine 106 produces substantially identical output for given input claims and configuration at any time. This prevents repudiation using issued claims. The configuration for a given direct trust in a security context is protected from unauthorized tampering to prevent inadvertent claims from being issued via a claims transformation engine 106 which could compromise the security of the security context 102.

The following illustrates an example implementation to ensure security of a security context and prevent attacks like repudiation and tampering of the claims issued by the claims transformation engine 106. In the case of claims egressing a security context 102, input claims are verified to be issued by a controller in the security context before claims transformation engine 106 acts on them. In some embodiments, this verification can be done by means of certificate signatures, such as Kerberos signatures. In this example, output claims are embedded in the Kerberos Ticket and signed using the shared key stored in the trust.

In the case of claims ingressing a security context, input claims are verified as issued by the trusted security context by checking the signature of a shared key certificate (such as a Kerberos ticket) using the shared key stored in the trust.

Output claims may be compared by applying a set of syntactic and semantic checks to assess which values are valid and in which combinations. For example, in some embodiments a claims dictionary can be used to ensure that only claims valid in the security context are issued, by determining which claim identifiers are valid. Any invalid claims or combinations are dropped. Output claims are embedded in a certificate, such as for example, a Kerberos ticket, which is signed by the root domain key to ensure their validity. Notably the Kerberos protocol is unable natively to carry claims. However, embodiments may use extentions, such as the MS-PAC available from Microsoft® Corporation of Redmond Wash. to enable the Kerberos protocol to carry the claims.

Embodiments may be implemented where the configuration 110 for a claims transformation engine 106 is protected by default. In these embodiments, administrators (or other specifically identified individuals) can modify the configuration 110. The claims dictionary is similarly protected. This prevents unauthorized changes to these configurations, thus preserving security of the security context.

As noted above, embodiments may include functionality to prevent detectable misconfigurations. The following illustrates detectable misconfigurations that may lead the claims transformation engine 106 to take appropriate defensive actions. If the configuration for the direct trust between two security contexts and a particular direction of claims traversal is deemed incorrect by the claims transformation engine 106, it will not allow any claims to traverse that trust in the particular direction. Thus, if configuration on a trust in a given direction is incorrect, including failure to parse the transformation rules, the claims transformation engine 106 does not allow any claims to traverse that trust in that direction.

The following illustrates other detectable misconfigurations that may lead the claims transformation engine 106 to take appropriate defensive actions. After handling the claims entering from a trust as per a valid configuration, the claims transformation engine 106 will block any claims that are not valid within the destination security authority. If the rules for a trust in the incoming direction are written in such a way that the output claims produced by the claims transformation engine 106 using the rules contains claims that are not defined in the security context, the undefined output claims are dropped by the security context.

As noted above, embodiments may be configured with default handling of claims crossing a direct trust between security contexts and security boundaries when no configuration is provided. The following illustrates default handling of claims crossing trusts within a security envelope. Claims egressing a security context are allowed as-is by default. This makes it easy for an administrator to configure the security authority on the other side of the security boundary. Claims ingressing a security context are examined for validity within the security context and all valid claims are allowed by default, if no corresponding configuration is made for the security boundary.

The following illustrates default handling of claims crossing trusts across a security boundary. Claims egressing a security boundary are allowed as-is by default. This makes it easy for an administrator to configure the security authority on the other side of the security boundary. Claims ingressing a security boundary are dropped by default, if no corresponding configuration is made for the security boundary. This is a secure behavior which prevents unexamined claims from entering any security context.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

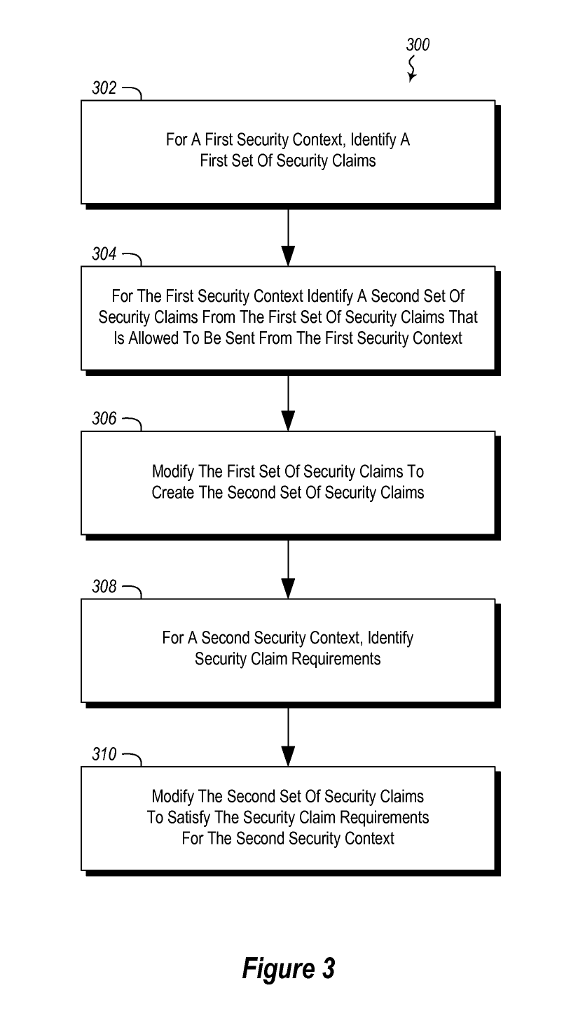

Referring now to FIG. 3, a method 300 is illustrated. The method 300 may be practiced in a computing environment having a plurality of security contexts. The method 300 includes acts for sharing security claims across different security contexts. The method 300 includes for a first security context, identifying a first set of security claims (act 302). For example, FIG. 1 illustrates a security context 102-1. FIG. 2 illustrates security contexts A and B. The security context 102-1 O^{Q} has an associated set of security claims 108-1. The security context 102-A has an associated set of security claims 108-A and 108-B.

The method 300 further includes for the first security context identifying a second set of security claims from the first set of security claims that is allowed to be sent from the first security context (act 304). For example, the set of claim 108-1′ may be the set of claims that is allowed to be sent from the security context 102-1. This set can be determined, for example, by the claims transformation engine 106-1. In FIG. 2, the sets of claims 108-A′ and 108-B′ may be the sets of claims that are allowed to be sent from the security context 102-A as determined by the claims transformation engines 106-Al and 106-A2, respectively.

The method 300 further includes modifying the first set of security claims to create the second set of security claims (act 306). For example, the claims transformation engine 106-1 may create the set of claims 108-1′ from the set of claims 108-1 for the security context 102-1. The claims transformation engine 106-A1 may create the set of claims 108-A′ from the set of claims 108-A. The claims transformation engine 106-A2 may create the set of claims 108-B′ from the set of claims 108-B.

The method 300 further includes for a second security context, identifying security claim requirements (act 308). For example, this may include determining the format of claims that should be allowed into the second security context, determining claims that should not be allowed into the second security context, etc. For example, the claims transformation engines 106-2 (FIG. 1), 106-B1, and 106-B2 may identify requirements for claims in their respective security contexts 102.

The method 300 further includes modifying the second set of security claims to satisfy the security claim requirements for the second security context (act 310). For example, the second set of security claims 108-1′ may be modified by the claims transformation engine 106-2 to the set of security claims 108-1″ such that set of security claims 108-1″ satisfy requirements for the security context 102-2. Similarly sets 108-A″ and 108-B″ shown in FIG. 2 may be created so as to satisfy security requirements for the security context 102-B.

While in the examples above, security claims traverse from security context 102-1 to security context 102-2 or from security context 102-A to 102-B, it should be appreciated that claim traversal can be bi-directional, such that claims can traverse from security context 102-2 to security context 102-1 or from security context 102-B to 102-A as well.

The method 300 may be practiced where modifying at least one of the first or the second set of security claims comprises filtering claims from the first or second set of security claims. For example, claims may be filtered out of claim sets 108-1 and/or 108-1′.

The method 300 may be practiced where modifying at least one of the first or the second set of security claims comprises substituting one or more claims for one or more claims in the first or second set of security claims. For example, claims in claim sets 108-1 and/or 108-1′ may be substituted for other claims.

The method 300 may be practiced where modifying at least one of the first or the second set of security claims comprises transforming one or more claims in the first or second set of security claims. For example, claims from claim sets 108-1 and/or 108-1′ may be essentially left intact, but transformed into a specific security context appropriate form.

The method 300 may be practiced where modifying at least one of the first or the second set of security claims comprises adding one or more claims to the first or second set of security claims. For example, additional claims may be added to claim sets 108-1 and/or 108-1′.

The method 300 may be practiced where at least one of modifying the first set of security claims or modifying the second set of security claims is performed according to a pre-specified default set of rules. For example, a claims transformation engine 106 may include default rules as to how a claim set is handled, either for ingressing or egressing claims.

The method 300 may further include receiving user input regarding configuration of claim handling. In some such embodiments, at least one of modifying the first set of security claims or modifying the second set of security claims is done according to the user input. For example, a user may specify what modifications should be done to claims in a claim set. Such specification may be through a user input, by a user supplying a configuration file, or by other means.

The method 300 may be practiced where modifying the first set of security claims to create the second set of security claims is performed to restrict what claims are allowed out of the first security context. For example, the claim set 108-1 can be modified to restrict claims from the claim set 108-1 from leaving the security context 102-1.

The method 300 may be practiced where modifying the second set of security claims is performed to restrict what claims are allowed into the second security context. For example, the claim set 108-1′ may be modified to prevent claims from that set from entering the security context 102-2.

The method 300 may further include detecting misconfigurations of claim sets from a security context perspective and as a result preventing security from being compromised. For example, modifying claim sets may result in security claim misconfiguration for a given security context. The misconfigurations could be detected and prevented from causing security to be compromised. For example, preventing security from being compromised may include preventing claims from being passed from the first security context. For example, referring to FIG. 1, if that is determined that the claim set 108-1′ might result in compromising security, the claim set 108-1′ can be prevented from leaving the security context 102-1. In an alternative or additional example, preventing security from being compromised may include preventing claims from being passed into the second security context. For example, if it is determined that the claim set 108-1′ contains modifications that include misconfigurations, then the claim set 108-1′ can be prevented from entering the security context 102-2.

The method 300 may be practiced where the first security context and the second security context belong to a common security envelope. Such an example is illustrated in FIG. 1 where both security contexts 102-1 and 102-2 are located in the security envelope below 104. Alternatively or additionally, the method 300 may be practiced where the first security context and the second security context belong to different security envelopes. Such an example is illustrated in FIG. 2, which illustrates a security context 102-A located in a first envelope 104-A and a second security context 102-B located in a second envelope 204-B.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment having a plurality of security contexts, a method of sharing security claims across different security contexts, the method comprising:
for a first security context, identifying a first set of security claims;
modifying the first set of security claims to create a second set of security claims that is allowed to be sent from the first security context;
for a second security context, identifying security claim requirements; and
modifying the second set of security claims to satisfy the security claim requirements for the second security context.

2. The method of claim 1, wherein modifying at least one of the first or the second set of security claims comprises filtering claims from the first or second set of security claims.

3. The method of claim 1, wherein modifying at least one of the first or the second set of security claims comprises substituting one or more claims for one or more claims in the first or second set of security claims.

4. The method of claim 1, wherein modifying at least one of the first or the second set of security claims comprises transforming one or more claims in the first or second set of security claims.

5. The method of claim 1, wherein modifying at least one of the first or the second set of security claims comprises adding one or more claims to the first or second set of security claims.

6. The method of claim 1 wherein modifying at least one of the first or second set of security claims is performed according to a pre-specified default set of rules.

7. The method of claim 1 further comprising receiving user input regarding configuration of claim handling and wherein at least one of modifying the first set of security claims or modifying the second set of security claims is done according to the user input.

8. The method of claim 1 wherein modifying the first set of security claims to create the second set of security claims is performed to restrict what claims are allowed out of the first security context.

9. The method of claim 1 wherein modifying the second set of security claims is performed to restrict what claims are allowed into the second security context.

10. The method of claim 1, further comprising detecting mis-configurations of claim sets from a security context perspective and as a result preventing security from being compromised.

11. The method of claim 9, wherein preventing security from being compromised comprises preventing claims from being passed from the first security context.

12. The method of claim 9, wherein preventing security from being compromised comprises preventing claims from being passed into the second security context.

13. The method of claim 1, wherein the first security context and the second security context belong to a common security envelope.

14. The method of claim 1, wherein the first security context and the second security context belong to different security envelopes.

15. One or more computer readable media comprising computer executable instructions that when executed by one or more processors cause one or more processors to perform the following:
for a first security context, identifying a first set of security claims;
modifying the first set of security claims to create a second set of security claims that is allowed to be sent from the first security context;
for a second security context, identifying security claim requirements; and
modifying the second set of security claims to satisfy the security claim requirements for the second security context.

16. The computer readable media of claim 15, wherein modifying at least one of the first or the second set of security claims comprises filtering claims from the first or second set of security claims.

17. The computer readable media of claim 15, wherein modifying at least one of the first or the second set of security claims comprises substituting one or more claims for one or more claims in the first or second set of security claims.

18. The computer readable media of claim 15, wherein modifying at least one of the first or the second set of security claims comprises transforming one or more claims in the first or second set of security claims.

19. The computer readable media of claim 15, wherein modifying at least one of the first or the second set of security claims comprises adding one or more claims to the first or second set of security claims.

20. In a computing environment having a plurality of security contexts, a computing system configured to share security claims across different security contexts, the system comprising:
a first security context, wherein the first security context comprises a scope within which claims are interpreted uniformly for the first security context;
a first claims transformation engine embodied in the first security context, wherein the first claims transformation engine is configured to:
identify a first set of security claims that are valid for the first security context; and
modify the first set of security claims to create a second set of security claims that is allowed to be sent from the first security context;
a second security context, wherein the second security context comprises a scope within which claims are interpreted uniformly for the second security context; and
a second claims transformation engine embodied in the second security context, wherein the second claims transformation engine is configured to modify the second set of security claims to satisfy the security claim requirements for the second security context.
